(19) United States
(12) Patent Application Publication
(10) Pub. No.: US 2014/0291048 A1
(43) Pub. Date: Oct. 2, 2014

(54) TANK FOR STORING COMPRESSED NATURAL GAS

(71) Applicant: GM GLOBAL TECHNOLOGY OPERATIONS LLC, Detroit, MI (US)

(72) Inventors: Arianna T. Morales, Royal Oak, MI (US); Mahmoud H. Abd Elhamid, Troy, MI (US); Anne M. Dailly, West Bloomfield, MI (US); Mei Cai, Bloomfield Hills, MI (US)

(73) Assignee: GM GLOBAL TECHNOLOGY OPERATIONS LLC, Detroit, MI (US)

(21) Appl. No.: 14/223,113

(22) Filed: Mar. 24, 2014

Related U.S. Application Data
(60) Provisional application No. 61/806,019, filed on Mar. 28, 2013.

(51) Int. Cl. F17C 1/14; B60K 15/03

(52) U.S. Cl. CPC F17C 1/14; B60K 15/03006; B60K 2015/03309
USPC 180/69.5; 220/581

(57) ABSTRACT

A tank for storing compressed natural gas (CNG) for fueling an automotive vehicle engine. The tank includes a container body for containing the CNG at a service pressure rating from about 20 MPa (megapascals) to about 30 MPa, the container body being formed from a single piece. The container body includes a head end region, a terminal end region distal to the head end region, and an intermediate region extending therebetween. The terminal end region and the head end region define an axial length of the container body. The container body is formed from an aluminum alloy. A valve member is operatively connected to, and in fluid communication with the container body via an opening defined in a wall of the container body. The container body wall has a thickness ranging from about 3 mm to about 10 mm.

### CROSS REFERENCE TO RELATED APPLICATIONS

This application claims the benefit of U.S. Provisional Patent Application Ser. No. 61/806,019 filed Mar. 28, 2013, which is incorporated by reference herein in its entirety.

### BACKGROUND

Pressure vessels, such as, e.g., gas storage containers and hydraulic accumulators may be used to contain fluids under pressure. It may be desirable to have a pressure vessel with relatively thin walls and low weight. For example, in a vehicle fuel tank, relatively thin walls allow for relatively low weight and thus for movement of the vehicle with greater energy efficiency.

### SUMMARY

Examples of the present disclosure include a tank for storing compressed natural gas (CNG) for fueling an automotive vehicle engine. The tank includes a container body for containing the CNG at a service pressure rating from about 20 MPa (megapascals) to about 30 MPa, the container body being formed from a single piece. The container body includes a head end region, a terminal end region distal to the head end region, and an intermediate region extending therebetween. The terminal end region and the head end region define an axial length of the container body. The container body is formed from an aluminum alloy. A valve member, for charging the container body with the gas or for drawing-off the gas from the container body, is operatively connected to, and in fluid communication with the container body via an opening defined in a wall of the container body. The container body wall has a thickness ranging from about 3 mm (millimeters) to about 10 mm.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a cross-sectional, semi-schematic view of an example of a tank according to the present disclosure;

FIG. 2 is a top, schematic view of an automotive vehicle trunk, showing an example of a tank in a portion of the trunk that is less likely to be used than the portion of the trunk immediately accessible via the trunk opening according to the present disclosure;

FIG. 3 is a top, schematic view of an automotive vehicle trunk, showing an example of several tanks connected together and distributed about portions of the trunk according to the present disclosure;

FIG. 4 is a rear, schematic view of the automotive vehicle trunk space, showing an example of an alternate arrangement of several tanks connected together and distributed about portions of the trunk according to the present disclosure; and

FIG. 5 is a schematic illustration of another example according to the present disclosure, showing several tanks operatively connected to a manifold.

### DETAILED DESCRIPTION

Natural gas vehicles are fitted with on-board storage tanks Some natural gas storage tanks are designated as low pressure tanks Low pressure natural gas tanks are normally rated for pressures up to about 750 psi. For example, the low pressure tank for a low pressure system may be rated for pressures of about 725 psi and lower. In other examples, the low pressure tank for the low pressure system may be rated for pressures up to a range of between about 300 psi and 1000 psi. During fueling, the container of the low pressure system storage tank is designed to fill until the tank achieves a pressure within the designated range. Designated low pressure system storage tanks are generally not rated for pressures above the designated range. In contrast, other natural gas storage tanks are designated high pressure tanks. High pressure natural gas tanks are normally rated for pressures ranging from about 3,000 psi (207 bar or 20.7 MPa) to about 3,600 psi (248 bar or 24.8 MPa). Similar to the low pressure tanks, the container of the high pressure natural gas storage tank is designed to fill until the tank achieves a pressure within the rated range. When the high pressure tanks are partially filled, i.e. filled to a pressure lower than the designated range, the amount of natural gas extractable from the tank may be insufficient to operate the vehicle for desired driving distance (i.e., to obtain a desirable mileage).

A Type 1 container according to the Federal Motor Vehicle Safety Standard (FMVSS) 304 is a metallic non-composite container (e.g., there is no composite overwrap). A typical Type 1 CNG tank for an automotive application is made from carbon steel. In addition to being heavy, carbon steel has low thermal conductivity, making it difficult to dissipate the heat during refueling. As used herein, carbon steel means steel that does not have a significant amount of alloy elements other than carbon. An example of carbon steel is Society of Automotive Engineers (SAE) 1000 series.

In contrast, examples of the present disclosure form high pressure CNG tanks from high strength aluminum alloys having tensile yield strengths higher than that of carbon steels. As used herein, a high strength aluminum alloy means an aluminum alloy with a tensile yield strength greater than 350 MPa. As such, the inventors of the present disclosure have discovered that it is possible to replace currently used carbon steel with, in one example, a lightweight aluminum alloy, such as a high strength aluminum alloy using about the same wall thickness and capacity (as currently used carbon steel tanks) to arrive at a tank that is lighter. Further, in another example of the present disclosure, instead of one larger tank, there are provided two or more smaller tanks, each having a smaller tank diameter than that of the example one larger tank. The smaller diameter tanks advantageously allow for even higher service pressure ratings than that for carbon steel tanks (e.g., 3600 psi).

Currently produced CNG tanks may occupy a large portion of the trunk space. For example, currently available CNG tanks may occupy half of the available trunk space. Some examples of the tank 10, 10′ of the present disclosure have a smaller diameter. In one example, the inner diameter of tank 10′ is about 4 inches. Smaller diameter tanks 10′ allow for a more efficient use of free space within the vehicle (e.g., trunk space) and underbody. In addition, thermal mass is greatly reduced when the diameter is much smaller. For example, a very large diameter tank (e.g., 16 inches (0.40 meter) or larger), filling could cause a temperature spike, e.g., of 25° C. (Celsius) or more. A natural gas temperature above 80° C. may be undesirable during filling.

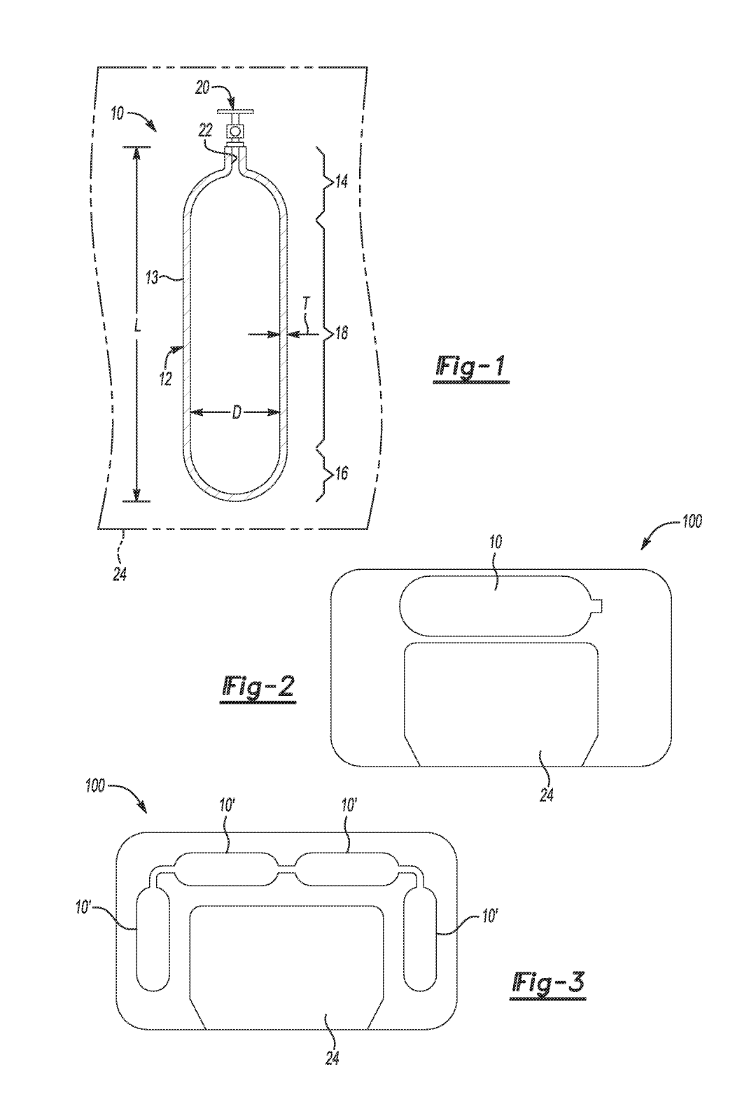

Referring now to FIG. 1, an example of the tank of the present disclosure is generally depicted at 10. Tank 10 is to store compressed natural gas (CNG) for fueling an automotive vehicle engine (not shown). The tank 10 includes a container body 12 for containing the gas at a service pressure rating higher than about 100 bar (about 1450 psi); or from about 200 bar (about 2901 psi) to about 300 bar (about 4351 psi). In another example, the tank 10 has a service pressure rating from about 20,684 kPa (about 207 bar/3,000 psi) to about 24,821 kPa (about 248 bar/3,600 psi).

The container body 12 may be integrally formed from a single piece. The container body 12 includes a head end region 14, a terminal end region 16 distal to the head end region, and an intermediate region 18 extending therebetween. The terminal end region 16 and the head end region 14 define an axial length L of the body. The intermediate region 18 may be substantially cylindrical in shape, with the terminal end region 16 being substantially cup-shaped; e.g., the terminal end region 16 may have the shape of a hemispherical cap. The head end region 14 may also be substantially cup-shaped; e.g., the head end region 14 may also have the shape of a hemispherical cap (not taking into account the portion having the opening and valve member, discussed further below).

As mentioned briefly above, in the example depicted in FIG. 1, the container body 12 is formed from a lightweight aluminum alloy. In an example, the lightweight aluminum alloy may be a high strength aluminum alloy, e.g. a 7000 series aluminum alloy. In yet another example, the aluminum alloy may be a 6000 series aluminum alloy. The tensile yield strength of the 6000 and 7000 series ranges from about 2758 bar (about 40000 psi) to about 5500 bar (about 79770 psi). The 6000 series and the 7000 series are naming conventions for wrought alloys, from the International Alloy Designation System. 7000 series aluminum alloys are alloyed with zinc, and can be precipitation hardened to the highest strengths of any aluminum alloy. 6000 series aluminum alloys are alloyed with magnesium and silicon, are easy to machine, and can be precipitation hardened, but not to the high strengths that 7000 series can reach.

Aluminum alloys such as the 7000 series have tensile yield strengths that are higher than those for carbon steels currently used to make Type 1 CNG tanks As an example, an aluminum 7075-T6 alloy has a tensile yield strength of about 73,000 psi, as compared to DIN1629, Grade St35.8/St37.5 carbon steel that has a tensile yield strength of about 34,000 psi.

In the example depicted in FIG. 1, tank 10 further includes a valve member 20, for charging the container body 12 with the gas or for drawing-off the gas from the container body 12. It is to be understood that manual and/or solenoid activated tank valves may be used in examples of the present disclosure. The valve member 20 is operatively connected to, and in fluid communication with the container body 12 via an opening 22 defined in a wall 13 of the container body 12, the container body wall 13 may have a thickness T ranging from about 3 mm to about 10 mm. It is to be understood that the opening 22 may be threaded for a typical tank valve (e.g., ¾×14 NGT (National Gas Taper) thread). Further, it is to be understood that opening 22 may be located at any area of wall 13 (for example, in intermediate region 18, terminal end region 16, etc.) and is not necessarily located at the end of head end region 14 as shown in FIG. 1.

Referring now additionally to FIG. 2, an example of a compressed natural gas onboard storage and delivery system 100 for an automotive vehicle includes the tank 10 operatively installed in a portion of a vehicle trunk 24 that is relatively less likely to be used than a central portion of the trunk space 24 that is easily accessible from the opening covered by the deck lid or hatch. For example, the space under the package tray, adjacent the seat, in a relatively long trunk may be harder to reach from the trunk opening, and therefore be less likely to be used for luggage or groceries than the space that is easily reached. The perimeter of the trunk space 24 (except the portion closest to the rear of the vehicle) may be less likely to be used for luggage or groceries. The trunk space 24 is shown schematically and in phantom in FIG. 1.

As mentioned briefly above, an example of the system 100 of the present disclosure includes two or more smaller tanks 10′. The tanks 10′ include the same component(s) and are formed in the same manner as discussed above regarding tank 10; however, the tanks 10′ have a smaller inner diameter D than that of tank 10. The length L may be the same length, shorter, or longer than the length L of tank 10. It is to be understood that each of tanks 10′ may be the same size and/or have the same capacity as each of the other tanks 10′, or at least one of the tanks 10′ may be a different size and/or have a different capacity from at least another of the tanks 10′. Examples of tanks 10′ may be formed from a lower strength aluminum alloy (such as aluminum 6061-T6) that has a lower tensile yield strength than alloy steel. The lower strength aluminum alloy may be used, at least in part due to the reduction of the hoop stress when using a smaller inner diameter D for tanks 10′.

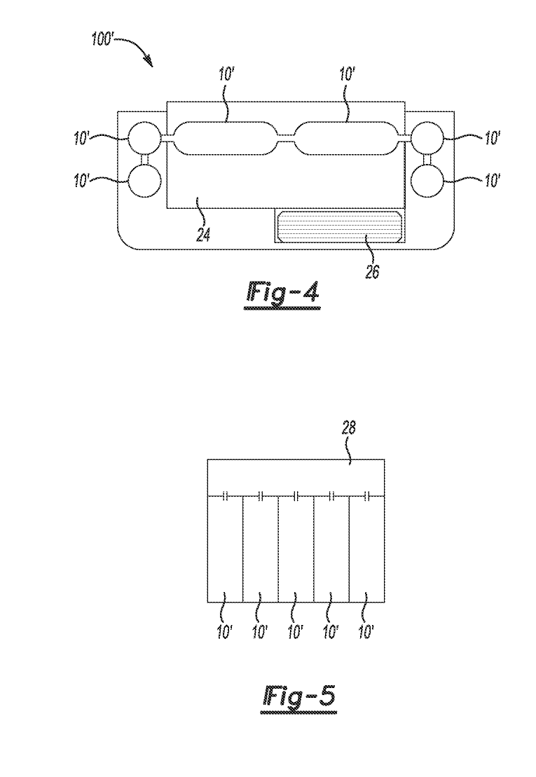

In an example, a plurality of the tanks 10′ are in operative fluid communication i) with each other (shown schematically in FIGS. 3 and 4); or ii) with a manifold 28 (shown schematically in FIG. 5). It is to be understood that one, several or all of the tanks 10′ may include valve member 20 and may be in operative fluid communication with the fuel system of the vehicle. If a manifold 28 is used, each tank 10′ has its own valve member 20, and the manifold 28 is in operative fluid communication with the fuel system of the vehicle. In another example, several smaller tanks 10′ are connected together with only one valve member 20 at the entrance to the one of the tanks 10′ that is connected to the orifice so as to be in operative communication with the fuel system.

According to an example of the present disclosure, an individual tank 10, 10′ has a weight ranging from about 2 kg (about 4.4 pounds) to about 41 kg (about 90 pounds). In another example, tank 10, 10′ has a weight ranging from about 15 kg (about 33 pounds) to about 27 kg (about 60 pounds). In yet a further example, the plurality of tanks 10′ together has a weight ranging from about 10 kg (about 22 pounds) to about 80 kg (about 176 pounds).

It is to be understood that the tank 10, 10′ may have any suitable inner diameter D and length L to render a particular volume and desired target GGE (Gasoline Gallon Equivalent). For the larger, single tank 10 implementation, the inner diameter D may range from about 24.1 cm (about 9.5 inches) to about 40.6 cm (about 16 inches); and the length L may range from about 76.2 cm (about 30 inches) to about 155 cm (about 61 inches). For the smaller, multiple tank 10′ implementation, the inner diameter D may range from about 7.6 cm (about 3 inches) to about 35 cm (about 14 inches); and the length L may range from up to about 60 cm (about 24 inches) to about 120 cm (about 47 inches) or longer.

As illustrated in FIGS. 3 and 4, the system 100, 100′ according to examples of the present disclosure distributes tanks 10′ about a portion of a vehicle trunk 24 that is relatively less likely to be used than a central portion of the trunk space 24 (such that most of the volume of the tank(s) 10, 10′ occupies the portion of a vehicle trunk 24 that is relatively less likely to be used). FIG. 4 shows an example with a different arrangement of tanks 10′. In this example, with a spare tire 26 being stored under the trunk space 24 floor, the tanks 10′ are located off to the sides and in the rear of the trunk space 24. For example, the tanks 10′ may be adjacent or beyond the hinge area for the deck lid (not shown). This would leave open for use the more easily accessible portions of the trunk space 24.

In another example, the tanks 10′ are disposed along the underbody of the vehicle, thereby leaving all the trunk space 24 open for the operator use for storage space. In a further alternate example, the tanks 10′ may be distributed about any suitable open space in the vehicle.

It is to be understood that examples of the tanks 10, 10′ as disclosed herein are designed so as to exhibit characteristics such as durability, strength, etc. and to have desirable venting, as would be expected of Type 1 CNG tanks

Tanks 10′ according to examples of the present disclosure may have individual volumes ranging from about 2 L to about 25 L (for each of the smaller, multiple tanks). Tank 10 according to examples of the present disclosure may have a volume ranging from about 30 L to about 150 L. In an example, the tank 10′ may have a natural gas capacity ranging from about 1 GGE to about 6 GGE. In an example for a larger tank 10, at 250 bar, for a 100 L volume, the CNG storage amount is about 190 g/L (grams per Liter). This would be about 8.2 GGE.

There are many advantages of examples of the present disclosure. The tanks 10, 10′ of the present disclosure are lighter, and they may provide increased fuel economy and better thermal management. Tanks 10, 10′ are also believed to be more resistant to contaminants in natural gas such as sulfur based compounds (e.g. hydrogen sulfide (H₂S)) and water. For example, some steel alloys are prone to stress corrosion cracking in H₂S environments, while aluminum is generally almost immune to H₂S induced stress corrosion cracking.

Further, CNG tanks made of carbon steel are relatively heavy compared to the aluminum tanks disclosed herein. A typical carbon steel tank may weigh from about 200 pounds to about 250 pounds. Replacing carbon steel with aluminum alloys as disclosed herein allows for reducing the weight of the tank by about a factor of 3 because of the difference between the density of aluminum and steel. For example, a tank that weighs 240 pounds of carbon steel could be replaced with a tank 10 made from an aluminum alloy as disclosed herein, having the same dimensions but only weighing 80 pounds. The weight savings on a vehicle that replaces two of the 240 pound carbon steel tanks with tanks 10 made from an aluminum alloy as disclosed herein would save about 160 pounds. This reduction in weight may improve the fuel economy of the natural gas fueled vehicle. It is estimated that a 100 pound reduction in weight may lead to an improvement in fuel economy ranging from about 1% to about 2%. Replacing carbon steel with aluminum alloys as disclosed herein may improve fuel economy by a factor of about 1.6% to about 3.2%. Natural gas powered vehicles generally have better (lower) regulated emissions than similar conventional gasoline powered vehicles. Improving the fuel economy by reducing the weight of the CNG tanks also improves (reduces) regulated emissions. Still further, aluminum also has a higher thermal conductivity than steel (about 3 times higher), making the aluminum alloys disclosed herein beneficial for CNG tank materials to reduce the temperature during refueling.

It is to be understood that the ranges provided herein include the stated range and any value or sub-range within the stated range. For example, a range from about 20 MPa to about 30 MPa should be interpreted to include not only the explicitly recited limits of about 20 MPa to about 30 MPa, but also to include individual values, such as 21 MPa, 24 MPa, etc., and sub-ranges, such as from about 22.5 MPa to about 27.5 MPa; from about 25.0 MPa to about 26.0 MPa, etc. Furthermore, when “about” is utilized to describe a value, this is meant to encompass minor variations (up to +/−10%) from the stated value.

In describing and claiming the examples disclosed herein, the singular forms “a”, “an”, and “the” include plural referents unless the context clearly dictates otherwise.

It is to be understood that the terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween).

Furthermore, reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

While several examples have been described in detail, it will be apparent to those skilled in the art that the disclosed examples may be modified. Therefore, the foregoing description is to be considered non-limiting.

What is claimed is:

1. A tank for storing compressed natural gas (CNG) for fueling an automotive vehicle engine, the tank comprising:
a container body for containing the CNG at a service pressure rating from about 20 MPa (megapascals) to about 30 MPa, the container body being formed from a single piece, the container body including a head end region, a terminal end region distal to the head end region, and an intermediate region extending therebetween, the terminal end region and the head end region defining an axial length of the container body, the container body being formed from an aluminum alloy; and
a valve member, for charging the container body with the gas or for drawing-off the gas from the container body, the valve member operatively connected to, and in fluid communication with the container body via an opening defined in a wall of the container body, the container body wall having a thickness ranging from about 3 mm (millimeters) to about 10 mm.

2. The tank as defined in claim 1 wherein the aluminum alloy is chosen from a 6000 series aluminum alloy or a 7000 series aluminum alloy, and has a tensile yield strength ranging from about 275 MPa to about 550 MPa.

3. The tank as defined in claim 1 wherein the tank has a weight ranging from about 5.9 kg to about 59 kg.

4. The tank as defined in claim 1 wherein the tank has an inner diameter ranging from about 10.2 cm (centimeters) to about 40.6 cm.

5. A compressed natural gas onboard storage and delivery system for an automotive vehicle, the system comprising:
the tank as defined in claim 1, operatively installed in a portion of a trunk space of the vehicle.

6. The system as defined in claim 5, further comprising a plurality of the tanks in operative fluid communication with i) each other or ii) a manifold, the plurality of tanks together having a weight ranging from about 10 kg to about 80 kg.

7. The system as defined in claim 6 wherein the plurality of tanks is distributed about a perimeter of the vehicle trunk space.

8. The system as defined in claim 5 wherein the tank is immune to stress corrosion cracking from natural gas contaminants.

9. The system as defined in claim 5 wherein the tank is lighter than an otherwise similar tank formed from steel.

10. The system as defined in claim 5 wherein the container body has a greater thermal conductivity than an otherwise similar container body formed from steel.

11. The system as defined in claim 5 wherein the system improves a fuel economy of a vehicle having the system onboard by a factor of about 1.6 percent to about 3.2 percent compared to the same vehicle having steel tanks for storing the natural gas.
